(19) United States
(12) Patent Application Publication
(10) Pub. No.: US 2006/0079279 A1
(43) Pub. Date: Apr. 13, 2006

(54) Mobille phone having the function of a mouse

(76) Inventor: Hsuan-Yu Lin, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/032,128

(22) Filed: Jan. 11, 2005

(30) Foreign Application Priority Data
Oct. 13, 2004 (TW) 093216236

(51) Int. Cl. H04B 1/38

(52) U.S. Cl. 455/557

(57) ABSTRACT

A mobile phone includes a base, a screen connected to the base, and a control panel; the base has a signal receiving plate, and a slide block on the upper side, which can slide on the base in any direction; the control panel has a connecting hole on a lower side, and it is joined to the slide block with the connecting protrusion being passed through the connecting hole; the control panel can be positioned such that when the control panel is slid on the base, the signal source will move within the signal receiving plate for the signal receiving plate to receive signals from the signal source; thus the control panel can function like a mouse; the control panel can be turned to such a position as not to cover the signal receiving plate, thus allowing one to input signals by means of touching the signal receiving plate.

### BACKGROUND OF THE INVENTION

1. Field of the Invention

The present invention relates to a mobile phone having the function of a mouse, more particularly one, which includes a signal receiving plate on a base, and a control panel having a signal source facing the signal receiving plate such that when the control panel is slid on the base, the signal source will move within the signal receiving plate for the signal receiving plate to receive signals, and in turn the mobile phone has the control panel to function like a mouse.

2. Brief Description of the Prior Art

Cellular phones provide people with convenience, allowing people to have phone conversation when they are driving or riding in a vehicle and from any location where signal transmission is OK between the phones and the base stations.

The various ways to control mobile phones include the use of directional (upward, downward, leftward, and rightward) buttons, and the use of touch screens, which are developed for suiting the powerful functions of modern mobile phones.

However, development of mobile phones are very fast, and modern mobile phones are made with more and more powerful functions, and the current ways to control mobile phones, e.g. the use of directional buttons and touch screens, don't seem to be convenient enough while people are using the advanced functions of modern mobile phones, e.g. the function for surfing on the Internet.

### SUMMARY OF THE INVENTION

It is a main object of the invention to provide a mobile phone having the function of a mouse to overcome the above disadvantage.

The mobile phone of the present invention includes a base, a screen connected to the base, and a control panel. The base has a signal receiving plate, and a slide block on the upper side, which can slide on the base in any direction. The control panel has a connecting hole on a lower side, and it is joined to the slide block with the connecting protrusion being passed through the connecting hole.

The control panel can be positioned such that when the control panel is slid on the base, the signal source will move within the signal receiving plate for the signal receiving plate to receive signals from the signal source; thus, the control panel can function like a mouse. The control panel can be turned to such a position as not to cover the signal receiving plate, thus allowing one to input signals by means of touching the signal receiving plate instead.

### BRIEF DESCRIPTION OF THE DRAWINGS

The present invention will be better understood by referring to the accompanying drawings, wherein:

FIG. 1 is an exploded perspective view of the mobile phone according to the present invention,

FIG. 2 is a view showing one way to use the mobile phone of the present invention, and

FIG. 3 is a view showing another way to use the mobile phone of the present invention.

### DETAILED DESCRIPTION OF THE PREFERRED EMBODIMENTS

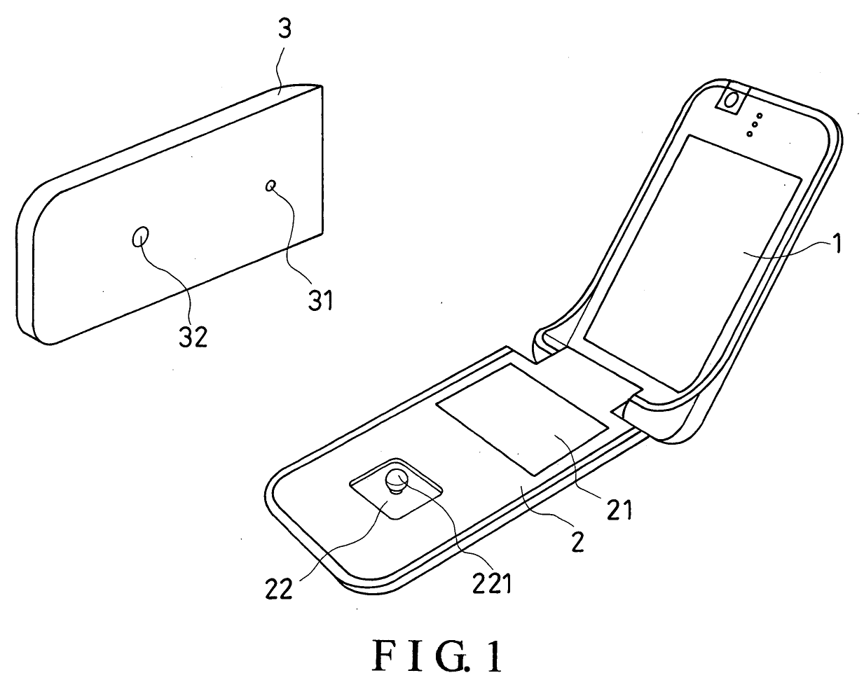

Referring to FIG. 1, a preferred embodiment of a mobile phone includes a screen 1, a base 2, and a control panel 3.

The base 2 is connected to the screen 1, and it has a signal receiving plate 21 on an upper side, and a slide block 22 capable of being slid on the base 2 in any direction. The signal receiving plate 21 can be a touch pad, a pressure type panel, a receiving plate of magnetism sensing type, a receiving plate of heat sensitive type or a receiving plate of light sensitive type. Furthermore, a connecting protrusion 221 is formed on the slide block 22.

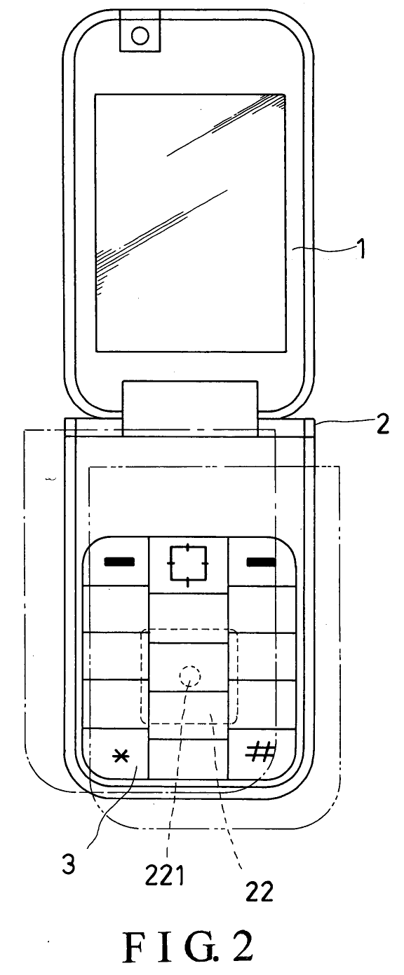

The control panel 3 has a signal source 31, and a connecting hole 32 on a lower side thereof. The slide block 22 and the control panel 3 are joined with the connecting protrusion 221 being passed through the connecting hole 32 and engaged with the control panel 3; thus, the control panel 3 can slide on the base 2, and the control panel 3 can be positioned in such a way that the signal source 31 is on the signal receiving plate 21 of the base 2, as shown in FIG. 2, and the control panel 3 can be angularly displaced relative to the base 2 to such a position as not to cover the signal receiving plate 21 of the base 2.

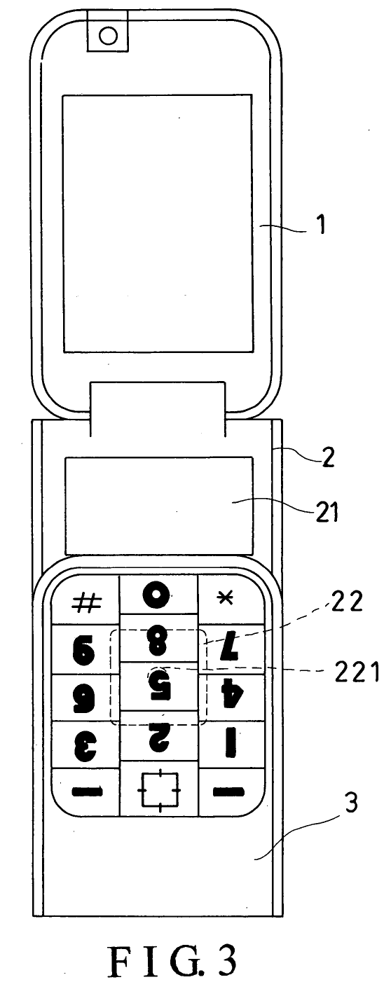

Therefore, the control panel 3 will function as a mouse when the user slides the control panel 3 on the base 2 so as to move the signal source 31 within the signal receiving plate 21, which can receive signals from the signal source 31. And, the user can input signals by means of touching the signal receiving plate 21 with his fingers instead of moving the control panel 3 when the control panel 3 is apart from the signal receiving plate 21, as shown in FIG. 3.

From the above description, it can be easily understood that when the control panel is slid on the base to move the signal source within the signal receiving plate, the signal receiving plate will receive signals from the signal source, and the cursor on the screen will move accordingly. Therefore, the control panel can be used as a mouse to help the user control the cursor when the user is using the Internet service and playing Internet game on the mobile phone. And, with such function, the mobile phone of the invention is very convenient to use when it comes to using Internet service on the mobile phone.

What is claimed is:

1. A mobile phone having a function of a mouse, comprising
a base having a signal receiving plate on an upper side thereof; the base having a slide block on the upper side, which can slide on the base;
a screen connected to the base; and
a control panel having a connecting hole on a lower side thereof;
the control panel being Joined to the slide block with the connecting protrusion being passed through the connecting hole and engaged with the control panel; the control panel being capable of being positioned such that the signal source will move within the signal receiving plate when the control panel is slid on the base, thus allowing the signal receiving plate to receive signals from the signal source;
whereby the mobile phone has the control panel to function like a mouse to help one person to use Internet service on the mobile phone.

2. The mobile phone as claimed in claim 1, wherein the control panel can be angularly displaced relative to the base to such a position as not to cover the signal receiving plate of the base, thus allowing one person to input signals by means of touching the signal receiving plate with his fingers instead.

3. The mobile phone as claimed in claim 1, wherein the signal receiving plate is a touch pad.

4. The mobile phone as claimed in claim 1, wherein the signal receiving plate is a pressure type panel.

5. The mobile phone as claimed in claim 1, wherein the signal receiving plate is a receiving plate of magnetism sensing type.

6. The mobile phone as claimed in claim 1, wherein the signal receiving plate is a receiving plate of heat sensitive type.

7. The mobile phone as claimed in claim 1, wherein the signal receiving plate is a receiving plate of light sensitive type.
